(19) United States
(12) Patent Application Publication
(10) Pub. No.: US 2020/0024471 A1
(43) Pub. Date: Jan. 23, 2020

(54) METHOD FOR FORMING SOFT TOUCH COATINGS

(71) Applicant: Arkema France, Colombes (FR)

(72) Inventors: Lisa Marie SPAGNOLA, Richboro, PA (US); Jeffrey A. KLANG, West Chester, PA (US); Manjuli GUPTA, Easton, PA (US)

(21) Appl. No.: 16/497,815

(22) PCT Filed: Mar. 12, 2018
(86) PCT No.: PCT/EP2018/056027

§ 371 Date: Sep. 26, 2019

Related U.S. Application Data
(60) Provisional application No. 62/477,619, filed on Mar. 28, 2017.

(51) Int. Cl. C09D 133/06; C08J 3/28; C08L 33/06; C08L 83/04; C08L 71/02; C08K 3/36; C08K 5/01; C08K 5/132

(52) U.S. Cl. CPC C09D 133/06; C08J 3/28; C08L 33/06; C08L 83/04; C08L 71/02; C08L 2666/58; C08K 5/01; C08K 5/132; C08L 2666/02; C08L 2666/30; C08K 3/36

(57) ABSTRACT

“Soft feel” coatings having improved haptic qualities are obtained by curing a coating composition containing at least one radiation-curable compound, at least one photoinitiator, at least one surface conditioner additive selected from the group consisting of particulate surface modification agents slip additives using a multistage curing procedure, involving exposing the coating composition to a long wavelength ultraviolet radiation source and then a short wavelength ultraviolet radiation source.

The present invention relates to methods of forming substrate coatings having a desirable “soft” touch or feel, using radiation-curable compositions.

Products with a soft feel coating or soft touch coating are desirable, as such coatings provide a more pleasing, luxurious feel to plastic, metal or other hard substrates. Conventional soft feel coatings have been based upon solvent- or water-borne two-part systems with polyurethane chemistry. While such coatings are advantageous with respect to feel, such coatings suffer from drawbacks including difficulties in formulating, limited shelf-life, long curing times and poor protective properties such as stain, chemical, abrasion and mar resistance. Consequently, it would be desirable to improve such coatings, in particular to find ways in which such coatings may be formulated to simultaneously provide prolonged storage stability (i.e., enhanced shelf life) and shorter cure times.

Representative examples of “soft feel” coating formulations known in the art may be summarized as follows:

DE 202012012632 discloses a UV-curable soft feel coating for pen grips. In the examples, this publication is directed to a soft feeling coating obtained using a mixture of difunctional oligomer and mono functional monomer that is radiation curable using a combination of different photoinitiators and a single wavelength of light.

JP 5000123 discloses the synthesis of a urethane acrylate oligomer which is capable of being used to create a radiation-curable coating.

JP 4778249B2 discloses a formulation that includes an acrylated silicone oligomer for a leather-type paint. The publication discloses types of light sources, the intensity of the light source and the time of exposure, but does not mention the possible use of lamps of different wavelengths of light.

U.S. Pat. No. 4,170,663 discloses forming a low gloss coating through the use of ionizing radiation, ultraviolet light and ionizing radiation in succession, wherein ultraviolet light absorbing pigment migrates to the surface of the coating. The coating achieved, however, is not a soft feel coating.

There has been interest in developing radiation-curable systems to replace the isocyanate-based polyurethane soft touch coatings that have conventionally been used. This is because radiation-curable systems do not contain free isocyanate (which may create certain health and safety risks), potentially provide improved durability, have effectively unlimited pot life, can be formulated to be free of water and non-reactive solvents (while still having suitably low viscosity in the uncured state) and can be cured more quickly (in seconds, rather than the minutes to hours typically needed for conventional polyurethane soft touch coatings). However, radiation-curable systems have certain challenges with respect to their use as soft feel coatings. Soft feel coatings generally rely on particulate surface modification agents such as silica, wax particles or polymer beads to create the surface texture needed to impart desirable haptic properties to the coating surface. Such additives need to break the surface of the resin matrix forming the coating, for the desired texture to be imparted. In solvent-borne and water-based systems, such as the majority of conventional polyurethane soft feel coating compositions, the drying of the coating composition after being applied to the surface of a substrate allows sufficient shrinkage that the particles of surface modification agent partially protrude from the dried/cured polyurethane matrix. In contrast, radiation-curable coating compositions, which typically do not contain any volatile carrier or solvent, exhibit minimal shrinkage. This means that the particles of surface modification agent remain substantially fully embedded within the cured resin, rather than extending in part above the layer of cured resin. This phenomena makes it difficult to achieve completely satisfactory soft feel coatings based on radiation-curable coating compositions.

It has now been discovered that significant improvements in the haptic qualities of a radiation-cured soft feel coating based on a radiation-curable coating composition containing one or more radiation-curable compounds (e.g., radiation-curable oligomers and/or monomers), photoinitiator(s) and one or more surface conditioner additives can be realized by curing the coating composition in a multi stage procedure wherein a layer of the coating composition on a substrate is exposed first to a long wavelength ultraviolet source and then to a short wavelength ultraviolet source. In circumstances where a particulate surface modification agent such as silica is used which does not impart slip properties to the cured coating, further improvements may be realized by additionally including at least one slip additive as a surface conditioner additive in the coating composition. Without wishing to be bound by theory, it is believed that the multi stage UV-cure allows the surface conditioner agent(s) to migrate to the surface of the coating composition layer during curing, thereby creating a more pleasing “soft” feel.

Various non-limiting aspects of the invention may be summarized as follows:

Aspect 1: A method for forming a soft touch coating on a surface of a substrate, comprising, consisting essentially of, or consisting of sequential (succession of) steps of:
a) applying a layer of a coating composition, comprised of at least one radiation-curable compound, at least one surface conditioner additive selected from the group consisting of slip additives and particulate surface modification agents and at least one photoinitiator, to at least a portion of the surface of the substrate;
b) exposing the layer of the coating composition to long wavelength ultraviolet radiation; and
c) exposing the layer of the coating composition to short wavelength ultraviolet radiation.

Aspect 2: The method of Aspect 1, wherein the at least one surface conditioner additive comprises, consists essentially of, or consists of at least one slip additive selected from the group consisting of polysiloxanes, natural and synthetic waxes and fluoropolymers, wherein the slip additive may optionally comprise at least one radiation-curable double bond.

Aspect 3: The method of Aspect 1, wherein the at least one surface conditioner additive comprises, consists essentially of or consists of at least one polysiloxane selected from the group consisting of silicone polyether copolymers and silicone acrylates.

Aspect 4: The method of any of Aspects 1-3 wherein the coating composition is comprised of from 0.2 to 20 percent by weight slip additive.

Aspect 5: The method of any of Aspects 1-4, wherein the at least one radiation-curable compound comprises, consists essentially of, or consists of at least one (meth)acrylate-functionalized monomer or oligomer selected from the group consisting of (meth)acrylate esters of aliphatic mono-alcohols, (meth)acrylate esters of alkoxylated aliphatic mono-alcohols, (meth)acrylate esters of aliphatic polyols, (meth)acrylate esters of alkoxylated aliphatic polyols, (meth)acrylate esters of aromatic alcohols, (meth)acrylate esters of alkoxylated aromatic alcohols, epoxy (meth)acrylates, polyether (meth)acrylates, urethane (meth)acrylates, polyester (meth)acrylates and amine- and sulfide-modified derivatives thereof and combinations thereof.

Aspect 6: The method of any of Aspects 1-5, wherein the coating composition is comprised of 50 to 99 percent by weight in total of radiation-curable compound (including, if present, the amount of any reactive slip additive).

Aspect 7: The method of any of Aspects 1-6, wherein the at least one surface conditioner additive comprises, consists essentially of, or consists of at least one particulate surface modification agent selected from the group consisting of silicas, polymer beads and wax particles.

Aspect 8: The method of any of Aspects 1-7, wherein the coating composition is comprised of from 0.2 to 30 percent by weight particulate surface modification agent.

Aspect 9: The method of any of Aspects 1-8, wherein the coating composition comprises at least one slip additive and at least one particulate surface modification agent.

Aspect 10: The method of any of Aspects 1-9, wherein the coating composition comprises at least one slip additive and at least one silica as a particulate surface modification agent.

Aspect 11: The method of any of Aspects 1-10, wherein the coating composition comprises at least one polysiloxane as a slip additive and at least one silica as a particulate surface modification agent.

Aspect 12: The method of any of Aspects 1-11, wherein the at least one photoinitiator comprises, consists essentially of, or consists of at least one photoinitiator selected from the group consisting of alpha-hydroxy ketones, phenylglyoxylates, benzyldimethylketals, alpha-aminoketones, mono-acyl phosphines, bis-acyl phosphines, metallocenes, phosphine oxides, benzoin ethers and benzophenones and combinations thereof.

Aspect 13: The method of any of Aspects 1-11, wherein the coating composition comprises a single photoinitiator which is capable of absorption of both short wavelength ultraviolet radiation and long wavelength ultraviolet radiation.

Aspect 14: The method of Aspect 13, wherein the single photoinitiator is selected from the group consisting of 2-hydroxy-2-methyl-1-phenyl-1-propanone, benzyl dimethyl ketal and 1-hydroxycyclohexylphenyl ketone.

Aspect 15: The method of any of Aspects 1-14, wherein the coating composition is comprised of from 0.1 to 10 percent by weight photoinitiator.

Aspect 16: The method of any of Aspects 1-12, wherein the coating composition is comprised of a first photoinitiator which is capable of absorption of short wavelength ultraviolet radiation and a second photoinitiator which is capable of absorption of long wavelength ultraviolet radiation.

Aspect 17: The method of any of Aspects 1-16, wherein the coating composition is comprised of not more than 1% by weight in total of non-reactive solvent and water.

Aspect 18: The method of any of Aspects 1-17, wherein the substrate is comprised of a material selected from the group consisting of thermoplastics, thermoset resins, ceramics, cellulosic materials, leather and metals.

Aspect 19: The method of any of Aspects 1-18, wherein the long wavelength UV light is supplied by one or more lamps selected from the group consisting of D bulb mercury lamps, V bulb mercury lamps and LED lamps.

Aspect 20: The method of any of Aspects 1-19, wherein the long wavelength UV light has a wavelength of from 300 to 420 nm or 320 to 400 nm.

Aspect 21: The method of any of Aspects 1-20, wherein the short wavelength UV light is supplied by one or more lamps selected from the group consisting of mercury arc lamps and H bulb lamps.

Aspect 22: The method of any of Aspects 1-21, wherein the short wavelength UV light has a wavelength of from 220 to 280 nm or 230 to 270 nm.

Aspect 23: The method of any of Aspects 1-22, wherein the layer of the coating composition has a thickness of from 4 to 200 microns or 10 to 75 microns.

Aspect 24: A substrate having a soft touch coating obtained by the method of any of Aspects 1-23.

In certain embodiments, the present invention provides a coating composition wherein one or more radiation-curable compounds (e.g., one or more (meth)acrylate-functionalized monomers and/or oligomers) are combined with at least one photoinitiator and at least one additive selected from the group consisting of slip additives and particulate surface modification agents. Such compositions are capable of being cured using ultraviolet radiation, wherein curing of the radiation-curable compound(s) due to free radical polymerization or other reaction involving the radiation-curable compound(s) takes place. A coating of the composition may preferably be applied to a surface of a substrate at ambient temperature or near ambient temperature, such as in the range of 10−35° C., although higher application temperatures could be used if so desired. Once applied, the composition may be cured, using both long wavelength and short wavelength ultraviolet (UV) light from suitable sources.

The layer of coating composition is exposed to the UV light for a time effective to cause cross-linking/polymerization of the radiation-curable compound(s). The intensity and/or wavelength of the UV light may be adjusted as desired to achieve the desired extent of curing. The time periods of exposure are not particularly limited, so long as the time periods, in combination, are effective to cure the coating composition into a viable article. Time frames for exposure to energy to cause sufficient cross-linking are not particularly limited and may be from several seconds to several minutes. The photoinitiator or photoinitiators may be selected so as to be activated at the wavelengths of the UV light to which the coating composition layer is exposed, whereby the UV light triggers decomposition of the photoinitiator and generates free radicals which initiate curing (e.g., polymerization and crosslinking) of the radiation-curable compound(s).

In various embodiments, the coating compositions described herein are liquid at ambient temperature (25° C.) with a viscosity of less than 4000 mPa·s (cP) or less than 3500 mPa·s (cP) or less than 3000 mPa·s (cP) or less than 2500 cPs or less than 2000 cPs or less than 1500 cPs or, most preferably, less than 1000 cPs. The coating compositions may have viscosities at 25° C. ranging from about 500 cPs to about 4000 cPs or from about 300 cPs to about 2000 cPs or from about 400 cPs to about 1500 cPs or from about 400 cPs to about 1000 cPs, as measured using a Brookfield viscometer, model DV-II, using a 27 spindle (with the spindle speed varying typically between 50 and 200 rpm, depending on viscosity). Such viscosities of the coating compositions described herein facilitate easy spreading of the compositions on a substrate for application as coatings and films.

The coating compositions may be applied to a substrate surface in any known conventional manner, for example, by spraying, knife coating, roller coating, casting, drum coating, dipping and the like and combinations thereof. Indirect application using a transfer process may also be used. A substrate may be any commercially relevant substrate, such as a high surface energy substrate or a low surface energy substrate, such as a metal substrate or plastic substrate, respectively. The substrates may comprise metal, cellulosic materials (such paper, cardboard and wood), ceramics (including glass), thermoplastics such as polyolefins, polycarbonate, acrylonitrile butadiene styrene (ABS) and blends thereof, composites (including laminates), leather and combinations thereof

### Radiation-Curable Compounds

Radiation-curable compounds suitable for use in the present invention may be generally described as ethylenically unsaturated compounds containing at least one carbon-carbon double bond, in particular a carbon-carbon double bond capable of participating in a free radical reaction, in particular a reaction initiated by ultraviolet radiation. Such reactions may result in a polymerization or curing whereby the radiation-curable compound becomes part of a polymerized matrix or polymeric chain. In various embodiments of the invention, the radiation-curable compound may contain one, two, three, four, five or more carbon-carbon double bonds per molecule. Combinations of multiple ethylenically unsaturated compounds containing different numbers of carbon-carbon double bonds may be utilized in the coating compositions of the present invention. The carbon-carbon double bond may be present as part of an α,β-unsaturated carbonyl moiety, e.g., an α,β-unsaturated ester moiety such as an acrylate functional group or a methacrylate functional group. A carbon-carbon double bond may also be present in the radiation-curable compound in the form of a vinyl group —CH═CH₂ (such as an allyl group, —CH₂—CH═CH₂). Two or more different types of functional groups containing carbon-carbon double bonds may be present in the radiation-curable compound. For example, the radiation-curable compound may contain two or more functional groups selected from the group consisting of vinyl groups (including allyl groups), acrylate groups, methacrylate groups and combinations thereof.

The coating compositions of the present invention may, in various embodiments, contain one or more (meth)acrylate functional compounds capable of undergoing free radical polymerization (curing) initiated by exposure to ultraviolet radiation. As used herein, the term “(meth)acrylate” refers to methacrylate (—O—C(═O)—C(CH₃)═CH₂) as well as acrylate (—O—C(═O)—CH═CH₂) functional groups. Suitable radiation-curable (meth)acrylates include compounds containing one, two, three, four or more (meth)acrylate functional groups per molecule; the radiation-curable (meth)acrylates may be oligomers or monomers or a combination of oligomer(s) and monomer(s).

Typically, the radiation-curable compound(s) will comprise the majority by weight of the coating compositions useful in the present invention. For example, the coating composition may contain 50 to 99 weight % in total of radiation-curable compound (e.g., (meth)acrylates), such amounts being based on the total weight of the coating composition.

Suitable radiation curable compounds include both monomers and oligomers, examples of each of which are discussed in more detail below.

### Radiation-Curable (Meth)Acrylate Oligomers

Suitable radiation-curable (meth)acrylate oligomers include, for example, polyester (meth)acrylates, epoxy (meth)acrylates, polyether (meth)acrylates, polyurethane (meth)acrylates (also sometimes referred to as urethane (meth)acrylates or urethane (meth)acrylate oligomers) and combinations thereof, as well as amine-modified and sulfide-modified variations thereof.

Exemplary polyester (meth)acrylates include the reaction products of acrylic or methacrylic acid or mixtures thereof with hydroxyl group-terminated polyester polyols. The reaction process may be conducted such that a significant concentration of residual hydroxyl groups remain in the polyester (meth)acrylate or may be conducted such that all or essentially all of the hydroxyl groups of the polyester polyol have been (meth)acrylated. The polyester polyols can be made by polycondensation reactions of polyhydroxyl functional components (in particular, diols) and polycarboxylic acid functional compounds (in particular, dicarboxylic acids and anhydrides). To prepare the polyester (meth)acrylates, the hydroxyl groups of the polyester polyols are then partially or fully esterified with reaction with (meth)acrylic acid, (meth)acryloyl chloride, (meth)acrylic anhydride or the like. Polyester (meth)acrylates may also be synthesized by reacting a hydroxyl-containing (meth)acrylate such as a hydroxyalkyl (meth)acrylate (e.g., hydroxyethyl acrylate) with a polycarboxylic acid. The polyhydroxyl functional and polycarboxylic acid functional components can each have linear, branched, cycloaliphatic or aromatic structures and can be used individually or as mixtures.

Examples of suitable epoxy (meth)acrylates include the reaction products of acrylic or methacrylic acid or mixtures thereof with glycidyl ethers or esters.

Exemplary polyether (meth)acrylates include, but are not limited to, the condensation reaction products of acrylic or methacrylic acid or mixtures thereof with polyetherols (also referred to as polyether polyols). Suitable polyetherols can be linear or branched substances containing ether bonds and terminal hydroxyl groups. Polyetherols can be prepared by ring opening polymerization of cyclic ethers such as tetrahydrofuran, 1,3-propylene oxide or alkylene oxides (e.g., ethylene oxide, propylene oxide, butane oxide and combinations thereof) with a starter molecule as well as by condensation of diols, in particular monomeric diols such as ethylene glycol, 1,2-propylene glycol, 1,3-propylene glycol and 1,4-butanediol. Suitable starter molecules include water, hydroxyl functional materials, polyester polyols and amines. A polyetherol may be esterified with a (meth)acrylate-containing reactant such as (meth)acryloyl chloride, (meth)acrylic anhydride or (meth)acrylic acid to obtain a polyether (meth)acrylate. In one desirable embodiment of the invention, the coating composition is comprised of at least one (meth)acrylate-functionalized polytetramethylene ether, in particular at least one di(meth)acrylate-functionalized polytetramethylene ether (e.g., a polytetramethylene ether glycol which has been esterified at its terminal hydroxyl groups with (meth)acrylic acid).

Polyurethane (meth)acrylates (sometimes also referred to as “urethane (meth)acrylates”) capable of being used in the coating compositions of the present invention include urethanes based on aliphatic and/or aromatic polyester polyols, polyether polyols and polycarbonate polyols and aliphatic and/or aromatic polyester diisocyanates and polyether diisocyanates capped with (meth)acrylate end-groups.

In various embodiments, the polyurethane (meth)acrylates may be prepared by reacting aliphatic and/or aromatic polyisocyanates (e.g., diisocyanates, triisocyanates) with OH group terminated polyester polyols (including aromatic, aliphatic and mixed aliphatic/aromatic polyester polyols), polyether polyols, polycarbonate polyols, polycaprolactone polyols, polydimethysiloxane polyols or polybutadiene polyols or combinations thereof to form isocyanate-functionalized oligomers which are then reacted in with hydroxyl-functionalized (meth)acrylates such as hydroxyethyl (meth)acrylate or hydroxypropyl (meth)acrylate to provide terminal (meth)acrylate groups. For example, the polyurethane (meth)acrylates may contain two, three, four or more (meth)acrylate functional groups per molecule. Other orders of addition may also be practiced to prepare the polyurethane (meth)acrylate, as is known in the art. For example, the hydroxyl-functionalized (meth)acrylate may be first reacted with a polyisocyanate to obtain an isocyanate-functionalized (meth)acrylate, which may then be reacted with an OH group terminated polyester polyol, polyether polyol, polycarbonate polyol, polycaprolactone polyol, polydimethysiloxane polyol, polybutadiene polyol or a combination thereof. In yet another embodiment, a polyisocyanate may be first reacted with a polyol, including any of the aforementioned types of polyols, to obtain an isocyanate-functionalized polyol, which is thereafter reacted with a hydroxyl-functionalized (meth)acrylate to yield a polyurethane (meth)acrylate. Alternatively, all the components may be combined and reacted at the same time.

Any of the above-mentioned types of oligomers may be modified with amines or sulfides (e.g., thiols), following procedures known in the art. Such amine- and sulfide-modified oligomers may be prepared, for example, by reacting a relatively small portion (e.g., 2-15%) of the (meth)acrylate functional groups present in the base oligomer with an amine (e.g., a secondary amine) or a sulfide (e.g., a thiol), wherein the modifying compound adds to the carbon-carbon double bond of the (meth)acrylate in a Michael addition reaction.

In various embodiments of the invention, the at least one radiation-curable (meth)acrylate oligomer (e.g., polyester (meth)acrylate oligomer and/or polyether (meth)acrylate oligomer) may be present in the coating composition in a total amount of from about 1% to about 70% by weight or from about 20% to about 65% by weight or from about 40% to about 60% by weight (such amounts being based on the total weight of all components of the coating composition, other than any non-reactive solvent or water that may be present).

### Radiation-Curable (Meth)Acrylate Monomers

Illustrative examples of suitable radiation-curable monomers include (meth)acrylated mono- and polyols (polyalcohols) and (meth)acrylated alkoxylated mono-alcohols and polyols. The mono-alcohols and polyols may be aliphatic (including one or more cycloaliphatic rings) or may contain one or more aromatic rings (as in the case of phenol or bisphenol A). “Alkoxylated” means that the base mono-alcohol or polyol has been reacted with one or more epoxides such as ethylene oxide and/or propylene oxide so as to introduce one or more ether moieties (e.g., —CH₂CH₂—O—) onto one or more hydroxyl groups of the mono-alcohol or polyol, prior to esterification to introduce one or more (meth)acrylate functional groups. For example, the amount of epoxide reacted with the mono-alcohol or polyol may be from about 1 to about 30 moles of epoxide per mole of mono-alcohol or polyol.

Examples of suitable mono-alcohols include, but are not limited to, straight chain, branched and cyclic C₁-C₅₄ mono-alcohols (which may be primary, secondary or tertiary alcohols). For instance, the mono-alcohol may be a C₁-C₇ aliphatic mono-alcohol. In another embodiment, the mono-alcohol may be a C₈-C₂₄ aliphatic mono-alcohol (e.g., lauryl alcohol, stearyl alcohol). Examples of suitable polyols include organic compounds containing two, three, four or more hydroxyl groups per molecule such as glycols (diols), e.g., ethylene glycol, 1,2- or 1,3-propylene glycol or 1,2-, 1,3- or 1,4-butylene glycol, hexanediols, neopentyl glycol, trimethylolpropane, pentraerythritol, glycerol and the like. In the case of a polyol or alkoxylated polyol, one or more of the hydroxyl groups of the polyol or aloxylated polyol may be (meth)acrylated; that is, the polyol or alkoxylated polyol may be partially or fully esterified ((meth)acrylated).

Representative, but not limiting, examples of suitable radiation-curable (meth)acrylate monomers include: 1,3-butylene glycol di(meth)acrylate, 1,4-butanediol di(meth)acrylate, 1,6-hexanediol di(meth)acrylate, longer chain aliphatic di(meth)acrylates (such as those generally corresponding to the formula H₂C═CRC(═O)—O—(CH₂)ₘ—O—C(═O)CR′═CH₂, wherein R and R′ are independently H or methyl and m is an integer of 8 to 24), alkoxylated (e.g., ethoxylated, propoxylated) hexanediol di(meth)acrylates, alkoxylated (e.g., ethoxylated, propoxylated) neopentyl glycol di(meth)acrylates, dodecyl di(meth) acrylates, cyclohexane dimethanol di(meth)acrylates, diethylene glycol di(meth)acrylates, dipropylene glycol di(meth)acrylates, alkoxylated (e.g., ethoxylated, propoxylated) bisphenol A di(meth)acrylates, ethylene glycol di(meth)acrylates, neopentyl glycol di(meth)acrylates, tricyclodecane dimethanol diacrylates, triethylene glycol di(meth)acrylates, tetraethylene glycol di(meth)acrylates, tripropylene glycol di(meth)acrylates, ditrimethylolpropane tetra(meth)acrylates, dipentaerythritol penta(meth)acrylates, alkoxylated (e.g., ethoxylated, propoxylated) pentaerythritol tetra(meth)acrylate, dipentaerythritol penta(meth)acrylates, pentaerythritol tetra(meth)acrylate, alkoxylated (e.g., ethoxylated, propoxylated) trimethylolpropane tri(meth)acrylates, alkoxylated (e.g., ethoxylated, propoxylated) glyceryl tri(meth)acrylates, trimethylolpropane tri(meth)acrylates, pentaerythritol tri(meth)acrylates, tris (2-hydroxy ethyl) isocyanurate tri(meth)acrylates, 2(2-ethoxyethoxy) ethyl (meth)acrylates, 2-phenoxyethyl (meth)acrylates, 3,3,5-trimethylcyclohexyl (meth)acrylates, alkoxylated lauryl (meth)acrylates, alkoxylated phenol (meth)acrylates, alkoxylated tetrahydrofurfuryl (meth)acrylates, caprolactone (meth)acrylates, cyclic trimethylolpropane formal (meth)acrylates, dicyclopentadienyl (meth)acrylates, diethylene glycol methyl ether (meth)acrylates, alkoxylated (e.g., ethoxylated, propoxylated) nonyl phenol (meth)acrylates, isobornyl (meth)acrylates, isodecyl (meth)acrylates, isooctyl (meth)acrylates, lauryl (meth)acrylates, methoxy polyethylene glycol (meth)acrylates, octyldecyl (meth)acrylates (also known as stearyl (meth)acrylates), tetrahydrofurfuryl (meth) acrylates, tridecyl (meth)acrylates, triethylene glycol ethyl ether (meth)acrylates, t-butyl cyclohexyl (meth)acrylates, dicyclopentadiene di(meth)acrylates, phenoxyethanol (meth)acrylates, octyl (meth)acrylates, decyl (meth)acrylates, dodecyl (meth)acrylates, tetradecyl (meth)acrylates, cetyl (meth)acrylates, hexadecyl (meth)acrylates, behenyl (meth)acrylates, diethylene glycol ethyl ether (meth)acrylates, diethylene glycol butyl ether (meth)acrylates, triethylene glycol methyl ether (meth)acrylates, dodecanediol di (meth)acrylates, dipentaerythritol penta/hexa(meth)acrylates, pentaerythritol tetra(meth)acrylates, alkoxylated (e.g., ethoxylated, propoxylated) pentaerythritol tetra(meth)acrylates, di-trimethylolpropane tetra(meth)acrylates, alkoxylated (e.g., ethoxylated, propoxylated) glyceryl tri(meth)acrylates and tris (2-hydroxy ethyl) isocyanurate tri(meth)acrylates and combinations thereof.

Generally speaking, in certain embodiments of the invention, it will be preferred to include in the coating composition one or more radiation-curable (meth)acrylate monomers that are mono- or di-functional (i.e., contain one or two (meth)acrylate groups per molecule) and which are aliphatic or alkoxylated. Examples of such (meth)acrylate monomers include propoxylated neopentyl glycol diacrylate, dodecanediol dimethacrylate, hexanediol diacrylate and lauryl acrylate.

According to certain embodiments of the invention, the coating composition is comprised of from about 1% to about 60% by weight or from about 10% to about 50% by weight or from about 20% to about 45% by weight in total of radiation-curable (meth)acrylate monomer (such amounts being based on the total weight of all components of the coating composition, other than any non-reactive solvent or water that may be present).

### Optional Carriers

In certain embodiments of the invention, the coating composition may contain water and/or one or more non-reactive solvents (e.g., organic solvents) which are capable of functioning as carriers for the other components of the composition.

However, in particularly advantageous embodiments of the present invention, the coating composition is formulated so as to contain little or no water and/or non-reactive solvent, e.g., not more than 10% or not more than 5% or not more than 1% or even 0% water and/or non-reactive solvent, based on the total weight of the coating composition. Such “high solids” compositions (which may be considered UV-curable 100% solids coating compositions) may be formulated using various components, including for example low viscosity reactive diluents, which are selected so as to render the composition sufficiently low in viscosity, even without solvent or water being present, that the composition can be easily applied at a suitable application temperature to a substrate surface so as to form a relatively thin, uniform coating layer.

In various embodiments of the invention, the coating compositions described herein have a viscosity of less than 4000 cPs or less than 3500 cPs or less than 3000 cPs or less than 2500 cPs or less than 2000 cPs or less than 1500 cPs or, most preferably, less than 1000 cPa, as measured at 25° C. using a Brookfield viscometer, model DV-II, using a 27 spindle (with the spindle speed varying typically between 50 and 200 rpm, depending on viscosity).

### Photoinitiators

The compositions described herein include at least one photoinitiator and are curable with radiant energy (in particular, ultraviolet radiation). The photoinitiator or photoinitiators are selected in accordance with the wavelengths of ultraviolet radiation emitted by the ultraviolet radiation sources used in the method of the present invention. That is, at least one photoinitiator is present in the composition which absorbs energy at the wavelength emitted by a short wavelength ultraviolet radiation source and at least one photoinitiator is present in the composition which absorbs energy at the wavelength emitted by a long wavelength ultraviolet radiation source. In one embodiment, the composition contains a single photoinitiator which absorbs energy at both long and short wavelengths (which may be referred to as a “dual wavelength photoinitiator”). In another embodiment, the composition contains both a first photoinitiator which absorbs energy at a short wavelength but not at a long wavelength and a second photoinitiator which absorbs energy at a long wavelength but not at a short wavelength (each of which may be referred to as a “single wavelength photoinitiator”). Other combinations are also possible, such as, for example, a dual wavelength photoinitiator in combination with one or more single wavelength photoinitiators, combinations of different dual wavelength photoinitiators and the like.

Accordingly, in one embodiment of the invention, a combination of photoinitiators is employed which possess different absorbance characteristics such that longer wavelength ultraviolet radiation can be used to excite or activate a photoinitiator or photoinitiators, while shorter wavelength ultraviolet radiation is used to excite one or more other photoinitiators which are present.

Suitable photoinitiators include, for example, alpha-hydroxy ketones, phenylglyoxylates, benzyldimethylketals, alpha-aminoketones, mono-acyl phosphines, bis-acyl phosphines, metallocenes, phosphine oxides, benzoin ethers and benzophenones and combinations thereof. Examples of suitable dual wavelength photoinitiators include, but are not limited to, 2-hydroxy-2-methyl-1-phenyl-1-propanone, benzyl dimethyl ketal and 1-hydroxycyclohexylphenyl ketone.

Suitable photoinitiators also include, but are not limited to, 2-methylanthraquinone, 2-ethylanthraquinone, 2-chloroanthraquinone, 2 benzyanthraquinone, 2-t-butylanthraquinone, 1,2-benzo-9,10-anthraquinone, benzyl, benzoin, benzoin methyl ether, benzoin ethyl ether, benzoin isopropyl ether, alpha-methylbenzoin, alpha-phenylbenzoin, Michler's ketone, benzophenone, 4,4′-bis-(diethylamino) benzophenone, acetophenone, 2,2 diethyloxyacetophenone, diethyloxyacetophenone, 2-isopropylthioxanthone, thioxanthone, diethyl thioxanthone, 1,5-acetonaphtlene, ethyl-p-dimethylaminobenzoate, benzil ketone, α-hydroxy keto, 2,4,6-trimethylbenzoyldiphenyl phosphine oxide, benzyl dimethyl ketal, benzil ketal (2,2-dimethoxy-1,2-diphenylethanone), 1-hydroxycyclohexyl phenyl ketone, 2-methyl-1-[4-(methylthio) phenyl]-2-morpholinopropanone-1, 2-hydroxy-2-methyl-1-phenyl-propanone, oligomeric α-hydroxy ketone, phenylbis(2,4,6-trimethylbenzoyl)phosphine oxide, ethyl-4-dimethylamino benzoate, ethyl(2,4,6-trimethylbenzoyl)phenyl phosphinate, anisoin, anthraquinone, anthraquinone-2-sulfonic acid, sodium salt monohydrate, (benzene) tricarbonylchromium, benzil, benzoin isobutyl ether, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2,4,6-trimethylbenzoyldiphenylphophine oxide, phenyl bis(2,4,6-trimethyl benzoyl)phosphine oxide, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, mixtures of benzophenone and methylbenzophenones, methybenzoylformate, 2-methyl-4′-(methylthio)-2-morpholinopropiophenone, phenanthrenequinone, 4′-phenoxyacetophenone, (cumene)cyclopentadienyl iron(ii) hexafluorophosphate, 9,10-diethoxy and 9,10-dibutoxyanthracene, 2-ethyl-9,10-dimethoxyanthracene, thioxanthen-9-one, oligo [2-hydroxy-2-methyl-1-[4-(1-methylvinyl)phenyl] propanone] and combinations thereof.

The amount of photoinitiator is not considered to be critical, but may be varied as may be appropriate depending upon the photoinitiator(s) selected, the amount of radiation-curable ethylenically unsaturated compound(s) present in the coating composition, the radiation source and the radiation conditions used, among other factors. Typically, however, the amount of photoinitiator may be from 0.05% to 10% by weight, based on the total weight of the coating composition. In certain embodiments, the coating composition is comprised of from 0.1 to 10 percent by weight photoinitiator (which may be a single photoinitiator, such as a dual wavelength photoinitiator or a combination of photoinitiators, such as a short wavelength photoinitiator and a long wavelength photoinitiator).

### Surface Conditioner Additives

The coating compositions employed in the method of the present invention comprise at least one surface conditioner additive selected from the group consisting of slip additives and particulate surface modification agents. These types of additives, which function to alter the haptic properties of the surface of the coating composition once cured, are discussed in more detail below. It is noted, however, that certain types of substances, such as waxes, may act as both slip additives and particulate surface modification agents.

In one embodiment, the coating composition is comprised of both at least one slip additive and at least one particulate surface modification agent. In particular, where the coating composition is comprised of at least one inorganic substance such as silica as a particulate surface modification agent, it is additionally comprised of at least one slip additive, such as, for example, at least one polysiloxane slip additive.

In addition to improving the haptic or tactile qualities of a coating composition, when the coating composition is cured as a layer on the surface of a substrate in accordance with the multi-stage method of the present invention, the surface conditioner additive(s) may enhance one or more other attributes of the cured coating composition, such as anti-blocking properties, abrasion resistance, water repellency and the like.

The total amount of surface conditioner additive present in the coating composition may vary significantly, depending upon the type(s) of surface conditioner additive selected for use. Typically, however, the coating composition may comprise from about 0.2 to about 40% by weight in total of surface conditioner additive.

### Slip Additives

The coating compositions utilized in the present invention may comprise at least one slip additive. Any of the slip additives known in the coatings art or combinations of such slip additives, may be employed. A slip additive is a component which functions to improve the “slip” of a surface. “Slip” is the relative movement between two objects that are in contact with each other. If an object is moved along a surface, there is a resistance acting in a direction opposite the movement. The resisting force is also called frictional force, wherein the friction results from the unevenness of the two surfaces in contact. The slip additive, which may or may not dissolve in or become solubilized in the coating composition before or after curing, serves to reduce the coefficient of friction of the cured coating obtained from the coating composition.

Suitable types of slip additives for use in the present invention include both reactive and non-reactive slip additives, such as polysiloxanes, natural and synthetic waxes and fluoropolymers. The term “polysiloxane” includes oligomeric and polymeric substances based on silicone chemistry, including both homopolymeric and copolymeric materials. Exemplary types of suitable polysiloxanes include polydialkylsiloxanes (e.g., polydimethylsiloxanes), silicone polyether copolymers (sometimes also referred to as polyoxyalkylenesiloxane copolymers, polyoxyalkylene methylalkylsiloxane copolymers or polysiloxane/polyether copolymers; the polyoxyalkylene portions of such copolymers may be based on ethylene oxide and/or propylene oxide, for example), polyether-modified silicones and silicone acrylates (e.g., silicone-modified polyacrylates). Suitable waxes include, for example, paraffin-based waxes and polyolefin (e.g., polypropylene and polyethylene)-based waxes. As recognized in the art, a “wax” is a naturally occurring or synthetic material which is solid at 20° C. (varying in consistency from soft and plastic to hard and brittle), has a melting point of at least 40° C. without decomposing and has a relatively low viscosity at temperatures slightly above its melting point and at such temperatures is non-stringing and capable of producing droplets (thus distinguishing waxes from high molecular weight polymers). Generally speaking, a wax will be relatively low in molecular weight (Mₙ<10,000). Suitable fluoropolymer slip additives include, for example, homopolymers and copolymers of tetrafluoroethylene, hexafluoropropylene and vinylidene fluoride, as well as perfluoroalkyl acrylates (e.g., perfluoro octyl acrylate) and perfluoropolyether acrylates (which are considered reactive slip additives, since they are capable of undergoing a polymerization or curing reaction with other radiation-curable compounds present in the coating composition) and similar substances. Fatty acid amides may also be utilized as slip additives, in particular saturated fatty acid amides. Slip additives useful in the coating compositions employed in the methods of the present invention are available from commercial sources including, for example, the slip additives sold by Evonik under the brand name TEGO® and the slip additives sold by BYK under various brand names.

The amount of slip additive present in the coating composition will depend upon a number of factors, including the identities of the slip additive(s) and other components employed in the coating composition and the particular haptic qualities desired in the cured coating obtained from the coating composition, but typically will be at least about 0.05 percent by weight based on the total weight of the coating composition. In certain embodiments, the coating composition is comprised of from 0.2 to 20 percent by weight slip additive, with higher concentrations of slip additive generally being preferred if the slip additive is a reactive slip additive. The amount of reactive slip additive, if any, is taken into account when calculating the total amount of radiation-curable compound present in the coating composition.

### Particulate Surface Modification Agents

The coating compositions of the present invention may contain one or more types of particulate surface modification agents, which are in particle form and generally do not dissolve in or become solubilized in the coating compositions both before and after the compositions are cured (i.e., they remain as discrete particles in the cured coating composition). Typically, such particulate surface modification agents are non-reactive, i.e., they do not react upon curing of the coating composition when the coating composition is exposed to ultraviolet radiation. Suitable particulate surface modification agents include those substances referred to in the coatings art as “matting agents”, “flattening agents” or “flatting agents”. Typically, the particulate surface modification agent will have an average particle size within the range of from about 0.02 microns to about 50 microns. Suitable particulate surface modification agents include both organic and inorganic substances, as well as combinations of organic and inorganic substances. Oligomeric and polymeric substances (e.g., waxes, thermoplastics as well as thermosets and crosslinked polymers) are examples of organic substances useful as particulate surface modification agents, particularly in the form of wax particles or polymer beads. Exemplary oligomers and polymers include, but are not limited to, poly(meth)acrylates (acrylic resins), polyurethanes, polyamides, polyolefins (e.g., polyethylenes, polypropylenes), polysilicones (e.g., silicone elastomers), fluoropolymers such as polytetrafluoroethylenes (PTFEs) and combinations thereof. The particulate surface modification agent may be in the form of a wax, e.g., a wax dispersion. Inorganic substances useful as particulate surface modification agents include silicas (including fumed or thermal silicas, silicates such as aluminum silicates as well as silica-containing substances such as diatomaceous earth, clays, talc and the like), metal hydroxides, metal oxides (e.g., alumina), inorganic carbonates such as calcium carbonate, calcium and zinc salts of fatty acids such as stearic acid and the like as well as organo-modified derivatives thereof (such as polymer-treated thermal silicas or polysiloxane-coated fumed silicas). When a silica is used as a particulate surface modification agent, it can be used in various forms including, but not limited to, amorphous, aerogel, diatomaceous, hydrogel, fumed, micronized, wax-treated and mixtures thereof. Silicas suitable for use as particulate surface modification agents in accordance with the present invention are available from commercial sources including, for example, the silicas sold by Evonik under the brand name ACEMATT®. In various embodiments, the particulate surface modification agents may be in the form of spherical beads or hollow beads.

The amount of particulate surface modification agent in the coating composition may vary depending upon the type(s) of particulate surface modification agent(s) employed as well as the haptic characteristics desired in the cured coating obtained from the coating composition. Typically, however, amounts of particulate surface modification agent within the range of from about 0.2 to about 30 percent by weight, based on the total weight of the coating composition, are suitable.

### Other Additives

The coating compositions of the present invention may optionally contain one or more additives instead of or in addition to the above-mentioned ingredients. Such additives include, but are not limited to, antioxidants, ultraviolet absorbers, photostabilizers, foam inhibitors, flow or leveling agents, colorants, pigments, dispersants (wetting agents) or other various additives, including any of the additives conventionally utilized in the coating art.

### Exemplary Formulations

In certain embodiments of the invention, the coating composition may comprise, consist essentially of or consist of the following components:

a) (meth)acrylate-functionalized compound(s);
b) optionally, dispersant(s);
c) particulate surface modification agent(s);
d) photoinitiator(s); and
e) slip additive(s).

In certain embodiments, the coating composition is comprised of 70-95% by weight a), 0-5% by weight b), 2-20% by weight c), 2-20% by weight d) and 0.1-5% by weight e), based on the total weight of a)-e). In other embodiments, the coating composition is comprised of 75-90% by weight a), 0.1-2% by weight b), 4-12% by weight c), 2-10% by weight d) and 0.5-3% by weight e), based on the total weight of a)-e).

### Substrates

A substrate to which the above-described coating composition may be applied and cured in accordance with the present invention may be any commercially relevant substrate, such as a high surface energy substrate or a low surface energy substrate, such as a metal substrate or plastic substrate, respectively. The substrates may comprise steel or other metal, paper, cardboard, glass or other type of ceramic, a thermoplastic such as a polyolefin, polycarbonate, acrylonitrile butadiene styrene or blends thereof, composites, wood, leather and combinations thereof.

### Exemplary Methods of Applying and Curing the Coating Compositions

In various embodiments, a method of coating a substrate with the coating compositions described herein may comprise, consist of, or consist essentially of applying the composition to a substrate (wherein, for example, the applied composition is in the form of a layer on a surface of a substrate) and curing the composition, wherein the curing comprises curing by exposing the coating composition to ultraviolet radiation of at least two different wavelengths (including long wavelength ultraviolet radiation, followed by short wavelength ultraviolet radiation). In various embodiments of the invention, the coating compositions may be applied to a substrate by a method selected from the group consisting of spraying, knife coating, roller coating, casting, drum coating, dipping and combinations thereof. A plurality of layers of a coating composition in accordance with the present invention may be applied to a substrate surface; the plurality of layers may be simultaneously cured or each layer may be successively cured before application of an additional layer of coating composition.

The thickness of the coating prepared from the coating compositions of the present invention may be varied as may be desired for a particular end use application, but typically will be in the range of from 4 microns to 200 microns. In one embodiment, the cured coating has a thickness of about 10 to about 75 microns.

To cure a layer of coating composition, the coating composition layer is successively exposed to sources of ultraviolet radiation of different wavelength. To achieve a cured coating having desirable haptic properties, it has been found that it is advantageous to first employ long wavelength ultraviolet radiation, followed by (either immediately or after a period of time) short wavelength ultraviolet radiation. The long wavelength UV radiation may, for example, be UV-A radiation or have a wavelength of from 300 to 420 nm or 320 to 400 nm. The long wavelength UV radiation may be supplied by one or more lamps selected from the group consisting of D bulb mercury lamps, V bulb mercury lamps and LED lamps. The short wavelength UV radiation may be UV-C radiation or have a wavelength of from 220 to 280 nm or 230 to 270 nm and may be supplied by one or more lamps selected from the group consisting of mercury arc lamps and H bulb lamps.

Generally speaking, light sources suitable for ultraviolet (UV) curing include arc lamps, such as carbon arc lamps, xenon arc lamps, mercury vapor lamps, tungsten halide lamps, lasers, sunlamps and fluorescent lamps with ultra-violet light emitting phosphors. Commercial UV/Visible light sources with varied spectral output in the range of 250-450 nm may be used for curing purposes, wherein wavelength selection can be achieved with the use of optical bandpass or longpass filters. However, the use of a filter may not be needed in the curing step wherein the coating composition layer is exposed to short wavelength ultraviolet radiation, provided the lamp used provides most of its energy in the short wavelength region (simultaneous exposure to some amount of long wavelength ultraviolet radiation during such step will generally not interfere with the desired further curing and development of cured coating properties).

Regardless of the light source, the emission spectrum of the lamp(s) must overlap the absorbance spectrum of the photoinitiator. Two aspects of the photoinitator absorbance spectrum need to be considered: the wavelength absorbed and the strength of absorption (molar extinction coefficient). For example, the photoinitiators oligo[2-hydroxy-2-methyl-1-[4-methylvinyl) phenyl]propanone] and diphenyl (2,4,6-trimethylbenzoyl) phosphine oxide have absorbance peaks at 225-290 nm (which is in the short UV wavelength range) and 320-380 nm (which is in the long UV wavelength range).

A layer of a coating composition in accordance with the invention may, for example, be applied to a substrate surface to provide a coated substrate, partially cured by exposure of the uncured coating composition layer to a source of long wavelength ultraviolet radiation, then fully cured by exposure of the partially cured coating composition layer to a source of short wavelength ultraviolet radiation. Typical exposure times may range, for example, from less than 1 second up to several minutes.

### Exemplary End Use Applications

In various embodiments of the invention, the coating compositions described herein may be used to provide coatings and/or films, such as coatings and/or films for automobiles and other motor vehicles (e.g., as coatings on armrests, dashboards, seating, switches, controls and other interior components), aeronautic components, small appliances, packaging (e.g., cosmetics packaging), printing enhancements (inks), top coats (overvarnishes) over inks in graphic arts applications, coatings on leathers and synthetic leathers and/or consumer electronics. For example, the coating compositions may be cured prior to use as coatings and/or films for such end use applications.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the curable composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Examples 1, 1B and 2

Three different coating compositions were prepared, in accordance with the following formulations (Tables 1-3). The silica used in these formulations as a particulate surface modification agent was a polymer-treated thermal silica (also characterized as a polysiloxane-coated fumed silica).

### Example 1

TABLE 1
(Example 1)

| Component | Mass (g) | Weight % |
|---|---|---|
| Diacrylate-functionalized | 24.00 | 52.46 |
| Polytetramethylene Ether | | |
| (Mₙ = ca. 650 g/mol) | | |
| Propoxylated Neopentyl | 16.00 | 34.97 |
| Glycol Diacrylate | | |
| Dispersant (structured acrylic | 0.35 | 0.77 |
| copolymer) | | |
| Silica | 3.40 | 7.43 |
| 2-Hydroxy-2-methyl-1- | 2.00 | 4.37 |
| phenyl-1-propanone | | |
| Total | 45.75 | 100.00 |

### Example 1B

TABLE 2
(Example 1B)

| Component | Mass (g) | Weight % |
|---|---|---|
| Diacrylate-functionalized | 24.00 | 51.68 |
| Polytetramethylene Ether | | |
| (Mₙ = ca. 650 g/mol) | | |
| Propoxylated Neopentyl | 16.00 | 34.45 |
| Glycol Diacrylate | | |
| Dispersant (structured acrylic | 0.35 | 0.76 |
| copolymer) | | |
| Silica | 3.40 | 7.32 |
| 2-Hydroxy-2-methyl-1- | 2.00 | 4.31 |
| phenyl-1-propanone | | |
| Slip Additive (Polyether | 0.69 | 1.48 |
| Siloxane Copolymer) | | |
| Total | 46.44 | 100.00 |

### Example 2

TABLE 3
(Example 2)

| Component | Mass (g) | Weight % |
|---|---|---|
| Diacrylate-functionalized | 39.00 | 51.22 |
| Polytetramethylene Ether | | |
| (Mₙ = ca. 650 g/mol) | | |
| Propoxylated Neopentyl Glycol | 26.00 | 34.15 |
| Diacrylate | | |
| Dispersant (structured acrylic | 0.57 | 0.75 |
| copolymer) | | |
| Silica | 5.53 | 7.26 |
| Diphenyl(2,4,6- | 1.95 | 2.56 |
| trimethylbenzoyl)phosphine | | |
| oxide | | |
| 70:30 (w/w) Blend of Oligo[2- | 1.95 | 2.56 |
| hydroxy-2-methyl-1-[4-(1- | | |
| methylvinyl)phenyl]propanone] | | |
| and 2-Hydroxy-2-methyl-1- | | |
| phenyl-1-propanone | | |
| Slip Additive (Polyether | 1.14 | 1.50 |
| Siloxane Copolymer) | | |
| Total | 76.14 | 100.00 |

The aforementioned formulations were drawn down on substrates as 1 mil thickness coatings and photocured using different conditions, as summarized in the following Table 4. The results obtained for the cured coatings are also described in the table.

TABLE 4

| Formulation | | | |
|---|---|---|---|
| Example | Cure Conditions | Feel | Gloss |
| 1 | 2 Mercury arc | Not Soft | 31.7 |
| | lamps, 400 W/in, | | |
| | 50 fpm | | |
| 1B | 2 Mercury arc | Not Soft | 33.9 |
| | lamps, 400 W/in, | | |
| | 50 fpm | | |
| 2 | V lamp 600 W/in + | Velvety | 10.4 |
| | 2 passes under 2 | | |
| | Mercury arc lamps, | | |
| | 50 fpm | | |
| 2 | V lamp 400 W/in + | Velvety | 8.8 |
| | 2 passes under 2 | | |
| | Mercury arc lamps, | | |
| | 50 fpm | | |
| 2 | 395 nm LED | Velvety | 8.2 |
| | 12 W/in + 2 passes | | |
| | under 2 Mercury arc | | |
| | lamps, 50 fpm | | |
| 2 | 395 nm LED 6 W/in + | Velvety | 5.9 |
| | 2 passes under 2 | | |
| | Mercury arc lamps, | | |
| | 50 fpm | | |

### Example 3

The following formulation (Table 5) was prepared as a coating composition. The silica used in this formulation as a particulate surface modification agent was a polymer-treated thermal silica (also characterized as a polysiloxane-coated fumed silica).

TABLE 5
(Example 3)

| Component | Mass (g) | Weight % |
|---|---|---|
| Acrylate Oligomer (Isocyanurate | 15.76 | 47.44 |
| Derivative) | | |
| Lauryl Acrylate | 7.88 | 23.72 |
| Propoxylated Neopentyl Glycol | 5.25 | 15.81 |
| Diacrylate | | |
| Dispersant (structured acrylic | 0.22 | 0.67 |
| copolymer) | | |
| Silica | 2.17 | 6.52 |
| Diphenyl(2,4,6- | 1.44 | 4.35 |
| trimethylbenzoyl)phosphine | | |
| oxide | | |
| Slip Additive (Polyether Siloxane | 0.49 | 1.48 |
| Copolymer) | | |
| Total | 33.22 | 100.00 |

The coating composition of Example was drawn down to a thickness of 3 mil on a substrate and photocured using the conditions shown in Table 6.

TABLE 6

| Formulation | | | |
|---|---|---|---|
| Example | Cure Conditions | Feel | Gloss |
| 3 | 2 Mercury arc | Not Soft | 38.2 |
| | lamps, 400 W/in, | | |
| | 50 fpm | | |
| 3 | V lamp 600 W/in + | Velvety | 6.7 |
| | H lamp 600 W/in, | | |
| | 50 fpm | | |

### Example 4

A coating composition was prepared based on the following formulation (Table 7). The silica used in this formulation as a particulate surface modification agent was a polymer-treated thermal silica (also characterized as a polysiloxane-coated fumed silica).

TABLE 7
(Example 4)

| Component | Mass (g) | Weight % |
|---|---|---|
| Diacrylate-functionalized | 12.00 | 50.35 |
| Polytetramethylene Ether | | |
| (Mₙ = ca. 650 g/mol) | | |
| Propoxylated Neopentyl | 8.00 | 33.57 |
| Glycol Diacrylate | | |
| Dispersant (structured acrylic | 0.18 | 0.74 |
| copolymer) | | |
| Silica | 1.70 | 7.13 |
| 1-Hydroxy-cyclohexyl- | 0.90 | 3.78 |
| phenyl-ketone | | |
| 2,4,6-Trimethylbenzoyl- | 0.30 | 1.26 |
| diphenyl phosphine oxide | | |
| Mixture of Benzophenones | 0.40 | 1.68 |
| and Methylbenzophenones | | |
| Slip Additive (Polyether | 0.36 | 1.50 |
| Siloxane Copolymer) | | |
| Total | 23.83 | 100.00 |

### Example 5

A coating composition was prepared based on the following formulation (Table 8). The silica used in this formulation as a particulate surface modification agent was a polymer-treated thermal silica (also characterized as a polysiloxane-coated fumed silica).

TABLE 8
(Example 5)

| Component | Mass (g) | Weight % |
|---|---|---|
| Diacrylate-functionalized | 12.00 | 51.67 |
| Polytetramethylene Ether | | |
| (Mₙ = ca. 650 g/mol) | | |
| Propoxylated Neopentyl Glycol | 8.00 | 34.45 |
| Diacrylate | | |
| Dispersant (structured acrylic | 0.18 | 0.76 |
| copolymer) | | |
| Silica | 1.7 | 7.32 |
| 50:50 Blend of 1-Hydroxy- | 1 | 4.31 |
| cyclohexyl-phenyl-ketone and | | |
| Benzophenone | | |
| Slip Additive (Polyether | 0.35 | 1.50 |
| Siloxane Copolymer) | | |
| Total | 23.22 | 100.00 |

The coating compositions of Examples 1B, 2 and 4-5 were drawn down to a thickness of 3 mil on a substrate and photocured using the conditions described in the following Table 9.

TABLE 9

| Formulation | | | |
|---|---|---|---|
| Example | Cure Conditions | Feel | Gloss |
| 1B | V lamp 600 W/in + H | Velvety | 1.4 |
| | lamp 600 W/in, 50 fpm | | |
| 4 | V lamp 600 W/in + H | Velvety | 3.2 |
| | lamp 600 W/in, 50 fpm | | |
| 2 | V lamp 600 W/in + H | Velvety/Rubbery | 1.4 |
| | lamp 600 W/in, 50 fpm | | |
| 5 | V lamp 600 W/in + H | Velvety | 2.0 |
| | lamp 600 W/in, 50 fpm | | |

1. A method for forming a soft touch coating on a surface of a substrate, comprising in succession the steps of:
a) applying a layer of a coating composition, comprised of at least one radiation-curable compound, at least one surface conditioner additive selected from the group consisting of slip additives and particulate surface modification agents and at least one photoinitiator, to at least a portion of the surface of the substrate;
b) exposing the layer of the coating composition to long wavelength ultraviolet radiation; and
c) exposing the layer of the coating composition to short wavelength ultraviolet radiation.

2. The method of claim 1, wherein the at least one surface conditioner additive comprises at least one slip additive selected from the group consisting of polysiloxanes, natural and synthetic waxes and fluoropolymers, wherein the slip additive may optionally comprise at least one radiation-curable double bond.

3. The method of claim 1, wherein the at least one surface conditioner additive comprises at least one polysiloxane selected from the group consisting of silicone polyether copolymers and silicone acrylates.

4. The method of claim 1, wherein the coating composition is comprised of from 0.2 to 20 percent by weight slip additive.

5. The method of any of claim 1, wherein the at least one radiation-curable compound comprises at least one (meth)acrylate-functionalized monomer or oligomer selected from the group consisting of (meth)acrylate esters of aliphatic mono-alcohols, (meth)acrylate esters of alkoxylated aliphatic mono-alcohols, (meth)acrylate esters of aliphatic polyols, (meth)acrylate esters of alkoxylated aliphatic polyols, (meth)acrylate esters of aromatic alcohols, (meth)acrylate esters of alkoxylated aromatic alcohols, epoxy (meth)acrylates, polyether (meth)acrylates, urethane (meth)acrylates, polyester (meth)acrylates and amine- and sulfide-modified derivatives thereof and combinations thereof.

6. The method of claim 1, wherein the coating composition is comprised of 50 to 99 percent by weight in total of radiation-curable compound.

7. The method of claim 1, wherein the at least one surface conditioner additive comprises at least one particulate surface modification agent selected from the group consisting of silicas, polymer beads and wax particles.

8. The method of claim 1, wherein the coating composition is comprised of from 0.2 to 30 percent by weight particulate surface modification agent.

9. The method of claim 1, wherein the coating composition comprises at least one slip additive and at least one particulate surface modification agent.

10. The method of claim 1, wherein the coating composition comprises at least one slip additive and at least one silica as a particulate surface modification agent.

11. The method of claim 1, wherein the coating composition comprises at least one polysiloxane as a slip additive and at least one silica as a particulate surface modification agent.

12. The method of claim 1, wherein the at least one photoinitiator comprises at least one photoinitiator selected from the group consisting of alpha-hydroxy ketones, phenylglyoxylates, benzyldimethylketals, alpha-aminoketones, mono-acyl phosphines, bis-acyl phosphines, metallocenes, phosphine oxides, benzoin ethers and benzophenones and combinations thereof.

13. The method of claim 1, wherein the coating composition comprises a single photoinitiator which is capable of absorption of both short wavelength ultraviolet radiation and long wavelength ultraviolet radiation.

14. The method of claim 13, wherein the single photoinitiator is selected from the group consisting of 2-hydroxy-2-methyl-1-phenyl-1-propanone, benzyl dimethyl ketal and 1-hydroxycyclohexylphenyl ketone.

15. The method of claim 1, wherein the coating composition is comprised of from 0.1 to 10 percent by weight photoinitiator.

16. The method of claim 1, wherein the coating composition is comprised of a first photoinitiator which is capable of absorption of short wavelength ultraviolet radiation and a second photoinitiator which is capable of absorption of long wavelength ultraviolet radiation.

17. The method of claim 1, wherein the coating composition is comprised of not more than 1% by weight in total of non-reactive solvent and water.

18. The method of claim 1, wherein the substrate is comprised of a material selected from the group consisting of thermoplastics, thermoset resins, ceramics, cellulosic materials, leather and metals.

19. The method of claim 1, wherein the long wavelength UV light is supplied by one or more lamps selected from the group consisting of D bulb mercury lamps, V bulb mercury lamps and LED lamps.

20. The method of claim 1, wherein the long wavelength UV light has a wavelength of from 300 to 420 nm or 320 to 400 nm.

21. The method of claim 1, wherein the short wavelength UV light is supplied by one or more lamps selected from the group consisting of mercury arc lamps and H bulb lamps.

22. The method of claim 1, wherein the short wavelength UV light has a wavelength of from 220 to 280 nm or 230 to 270 nm.

23. The method of claim 1, wherein the layer of the coating composition has a thickness of from 4 to 200 microns or from 10 to 75 microns.

24. A substrate having a soft touch coating obtained by the method of claim 1.
